(19) United States
(12) Patent Application Publication
(10) Pub. No.: US 2010/0208573 A1
(43) Pub. Date: Aug. 19, 2010

(54) METHOD AND DEVICE FOR DETECTING FERROELECTRIC POLARIZATION

(75) Inventor: Donald E. Adams, Pleasanton, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 12/542,453

(22) Filed: Aug. 17, 2009

Related U.S. Application Data
(60) Provisional application No. 61/089,276, filed on Aug. 15, 2008.

(51) Int. Cl. G11B 9/00

(52) U.S. Cl. 369/126; G9B/9

(57) ABSTRACT

An information storage device comprises a media including a ferroelectric layer and a conductive layer and a cantilever adapted to be actuated toward the media. A tip extends from the cantilever and an electrode associated with the cantilever. When the cantilever is actuated, the tip applies a contact force to strain the media so that a charge is coupled from the ferroelectric layer to the tip. A signal is applied to the electrode to generate electrostatic force between the electrode and the conductive layer, causing the cantilever to vibrate based on a frequency of the signal. Vibration of the cantilever causes the contact force applied by the tip to the media to vary. Polarization of the ferroelectric layer can be determined based on one or both of a baseband signal generated by the charge accumulated at the tip and an upper-band signal generated by the variation in phase of the charge accumulated at the tip.

### PRIORITY CLAIM

This application claims priority to the following U.S. Provisional Patent Application:

U.S. Provisional Patent Application No. 61/089,276, entitled “Method and Device for Detecting Ferroelectric Polarization,” by Donald E. Adams, filed Aug. 15, 2008, Attorney Docket No. NANO-01104US0.

### BACKGROUND

Software developers continue to develop steadily more data intensive products, such as ever-more sophisticated, and graphic intensive applications and operating systems. As a result, higher capacity memory, both volatile and non-volatile, has been in persistent demand Added to this demand is the need for capacity for storing data and media files, and the confluence of personal computing and consumer electronics in the form of portable media players (PMPs), personal digital assistants (PDAs), sophisticated mobile phones, and laptop computers, all of which place a premium on compactness and reliability.

Nearly every personal computer and server in use today contains one or more hard disk drives (HDD) for permanently storing frequently accessed data. Every mainframe and supercomputer is connected to hundreds of HDDs. Consumer electronic goods ranging from camcorders to digital data recorders use HDDs. While HDDs store large amounts of data, HDDs consume a great deal of power, require long access times, and require “spin-up” time on power-up. Further, HDD technology based on magnetic recording technology is approaching a physical limitation due to super paramagnetic phenomenon. Data storage devices based on scanning probe microscopy (SPM) techniques have been studied as future ultra-high density (>1 Tbit/in2) systems. There is a need for techniques and structures to read and write to a media that facilitate desirable data bit transfer rates and areal densities.

### BRIEF DESCRIPTION OF THE DRAWINGS

Further details of the present invention are explained with the help of the attached drawings in which:

FIG. 1 is a cross-sectional side view of an information storage device including a plurality of tips extending from corresponding cantilevers toward a movable media.

FIG. 2A is a plan view of a cantilever for use with embodiments of systems and methods in accordance with the present invention with tip extending therefrom and pivotable about a fulcrum by electrostatic force.

FIG. 2B is a cross-sectional side-view of the cantilever of FIG. 2A taken along the center of the cantilever and through the tip.

FIG. 3A is a plan view of a cantilever for use with alternative embodiments of systems and methods in accordance with the present invention with tip extending therefrom and pivotable about a fulcrum by electrostatic force.

FIG. 3B is a cross-sectional side-view of the cantilever of FIG. 3A taken off-center from the tip.

FIG. 3C is a cross-sectional side-view of the cantilever of FIG. 3A taken along the center of the cantilever and through the tip.

FIG. 4A is a plot of tip charge relative to applied force for a probe tip of an atomic force microscope.

FIG. 4B is a simplified schematic representation of plot of a recording layer of a media in a relaxed state.

FIG. 4C is a simplified schematic representation of plot of a recording layer of a media in a strained state induced by contact of a tip with the surface of the media.

FIG. 5 is a plot comparing applied force by a tip extending from a cantilever vibrating at a low frequency and a tip extending from a cantilever vibrating at resonance.

FIG. 6 shows composite spectra for tip charge as the tip moves along the media.

FIG. 7A is a schematic view of an embodiment of a front-end channel for use with systems and methods in accordance with the present invention to read information from a ferroelectric media in accordance with the present invention.

FIG. 7B is a schematic view of an alternative embodiment of a front-end channel for use with systems and methods in accordance with the present invention to read information from a ferroelectric media in accordance with the present invention.

FIG. 8A is a plot of signals from a simulation of the embodiment of FIG. 7A including media polarization and voltage from a low-noise charge amplifier.

FIG. 8B is a plot of signals from the simulation of FIG. 8A wherein the voltage from the low-noise charge amplifier is sent to an integrate-and-dump filter.

FIG. 9A is a schematic view of a further embodiment of a front-end channel for use with systems and methods in accordance with the present invention to read information from a ferroelectric media in accordance with the present invention.

FIG. 9B is a schematic view of a still further embodiment of a front-end channel for use with systems and methods in accordance with the present invention to read information from a ferroelectric media in accordance with the present invention.

FIG. 10A is a plot of signals from a simulation of the embodiment of FIG. 9A including media polarization and voltage from a low-noise charge amplifier.

FIG. 10B is a plot of signals from the simulation of FIG. 10A wherein the voltage from the low-noise charge amplifier is sent to an integrate-and-dump filter.

FIG. 11 is a circuit schematic for the front-end channel of FIG. 9A.

FIG. 12A is a schematic view of a further embodiment of a front-end channel for use with systems and methods in accordance with the present invention to read information from a ferroelectric media in accordance with the present invention.

FIG. 12B is a schematic view of a still further embodiment of a front-end channel for use with systems and methods in accordance with the present invention to read information from a ferroelectric media in accordance with the present invention.

FIG. 12C is a circuit schematic for the front-end channel of FIGS. 12A and 12B.

FIG. 13 is plot of probability error over bit time for different measurement techniques.

FIG. 14 is a schematic view of a front-end channel associated with multiple tips to access information from the media.

### DETAILED DESCRIPTION

Common reference numerals are used throughout the drawings and detailed description to indicate like elements; therefore, reference numerals used in a drawing may or may not be referenced in the detailed description specific to such drawing if the associated element is described elsewhere.

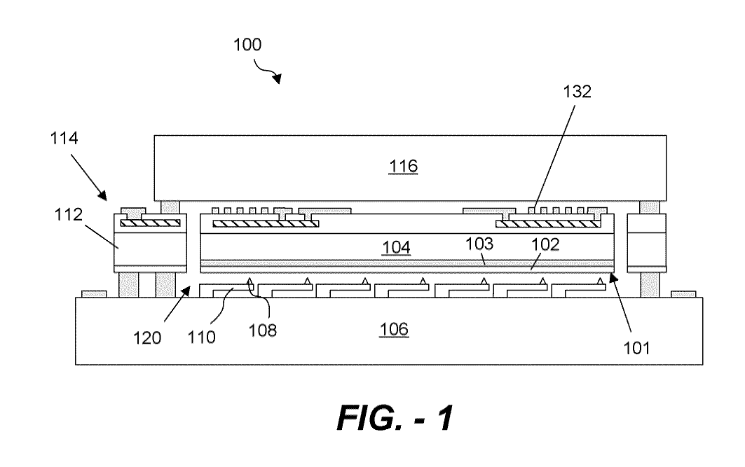

FIG. 1 is a simplified cross-sectional diagram of a system for storing information 100 (also referred to herein as an information storage device) with which embodiments of systems and methods for determining ferroelectric polarization in a ferroelectric media in accordance with the present invention can be used. Ferroelectric films have been proposed as promising recording media, with a bit state corresponding to a spontaneous polarization direction of the media, wherein the spontaneous polarization direction is controllable by way of application of an electric field. Information storage devices enabling potentially higher density storage relative to current ferromagnetic and solid state storage technology can include nanometer-scale heads such as contact probe tips, non-contact probe tips, and the like capable of one or both of reading and writing to a media. Information storage devices for high density storage can include seek-and-scan probe (SSP) devices comprising cantilevers from which probe tips extend for communicating with a media using scanning-probe techniques. The cantilevers and probe tips can be implemented in a micro-electromechanical systems (MEMS) device with a plurality of read-write channels working in parallel. Probe tips are hereinafter referred to as tips and can comprise structures that communicate with a media in one or more of contact, near contact, and non-contact mode. A tip need not be a protruding structure. For example, in some embodiments, a tip can comprise a cantilever or a portion of the cantilever.

The information storage device 100 of FIG. 1 comprises a tip substrate 106 arranged substantially parallel to a media 101. Cantilevers 110 extend from the tip substrate 106, and tips 108 extend from respective cantilevers 110 toward the surface of the media 101. The media 101 (or media stack) includes a recording layer 102 comprising one or more layers of patterned and/or unpatterned ferroelectric films disposed over a conductive layer (also referred to herein as a bottom electrode) 103. The conductive layer 103 can be formed over a substrate or insulating layer. Information can be stored in the ferroelectric recording layer 102 as a spontaneous polarization either in a “+” (or “UP”) direction corresponding to one of “0” and “1,” or a “−” (or “DOWN”) direction, corresponding to the other of “0” and “1.” The ferroelectric recording layer 102 can achieve ultra high bit recording density because the thickness of a 180° domain wall in ferroelectric material is in the range of a few lattices (1-2 nm). The media 101 is associated with a movable media platform 104. The movable media platform 104 is suspended and movable within a media frame 112 of a media substrate 114, for example by flexure structures (not shown). The media platform 104 can be urged within the frame 112 by way of thermal actuators, piezoelectric actuators, voice coil motors 132, etc. The tip substrate 106 and a cap 116 can be bonded with the media frame 112 on opposite surfaces of the media frame 112 to seal the media platform 104 within a cavity 120 between the cap 116 and tip substrate 106. Optionally, nitrogen or some other passivation gas can be introduced and sealed in the cavity 120. In alternative embodiments, information storage devices can be employed wherein a tip platform can be urged relative to the media, or alternatively wherein both the tip platform and media can be urged.

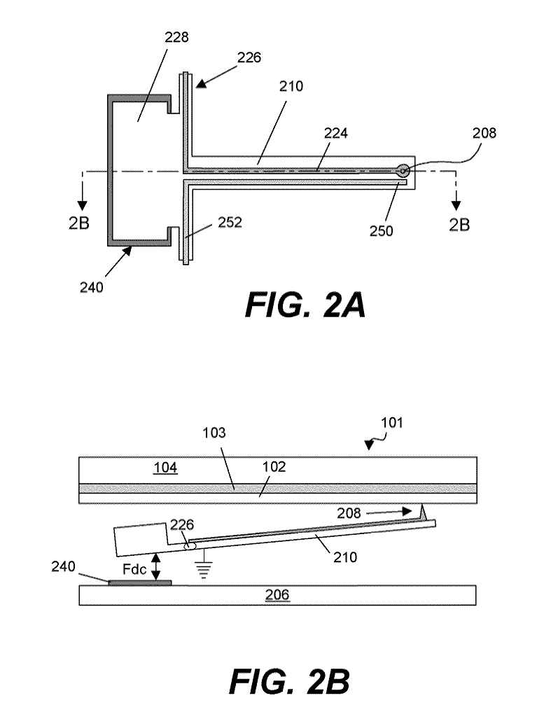

FIG. 2A is a plan view and FIG. 2B is a cross-sectional side-view of an embodiment of a cantilever 210 for use with embodiments of systems and methods in accordance with the present invention. The cantilever 210 is connected and electrically grounded through a tip substrate 206 by way of a torsion beam 226 connected at both ends to beam anchors (not shown). A tip 208 extends from the cantilever 210 toward the media 102 and is preferably connected with circuitry by a trace 224 electrically isolated from the cantilever 210 by an insulating layer. A proximal end 228 of the cantilever 210 (on the left side of the torsion beam 226 in FIG. 2A) is arranged opposite an actuation electrode 240 formed on the tip substrate 206. The torsion beam 226 acts as a fulcrum and the cantilever 210 is pivoted at the torsion beam 226 when a voltage potential (i.e., a DC voltage, F_{dc}) is applied to the actuation electrode 240 causing electrostatic force to attract the proximal end 228 of the cantilever 210 to the actuation electrode 240. As the cantilever 210 pivots the tip 208 at the distal end of the cantilever 210 is urged toward the media 101 and can be placed in contact or near contact with the surface of the media 101. A cantilever pivotable at a torsion beam (also referred to herein interchangeably as one or both of a see-saw and a teeter-totter structure) can allow a tip to be selectively placed in contact or near-contact with a surface of a ferroelectric media. Such an arrangement can reduce wear on inactive tip(s) and/or associate selected tip(s) with read/write circuitry to reduce surface area dedicated to circuitry by way of shared traces and circuit components.

Myriad different techniques can be applied to write and/or read the information stored in the ferroelectric recording layer. One such technique is described in U.S. Ser. No. 11/688,806 entitled “SYSTEMS AND METHODS OF WRITING AND READING A FERRO-ELECTRIC MEDIA WITH A PROBE TIP,” by Adams et al., incorporated herein by reference. The technique comprises urging one of the ferroelectric media and the tip so that the tip passes across the surface of the media with electric charge coupling to the tip. The tip acts as an antenna and the charge coupled to the tip varies with polarization at a frequency determined by the rate of relative movement between the media and the tip and the length of the bit. The signal is amplified and data is extracted from the signal. As shown in FIG. 2A, in some embodiments the cantilever structure can also include a guard trace 252 and guard 250 for reducing interference from stray electric fields, thereby improving signal-to-noise ratio (SNR) for such techniques.

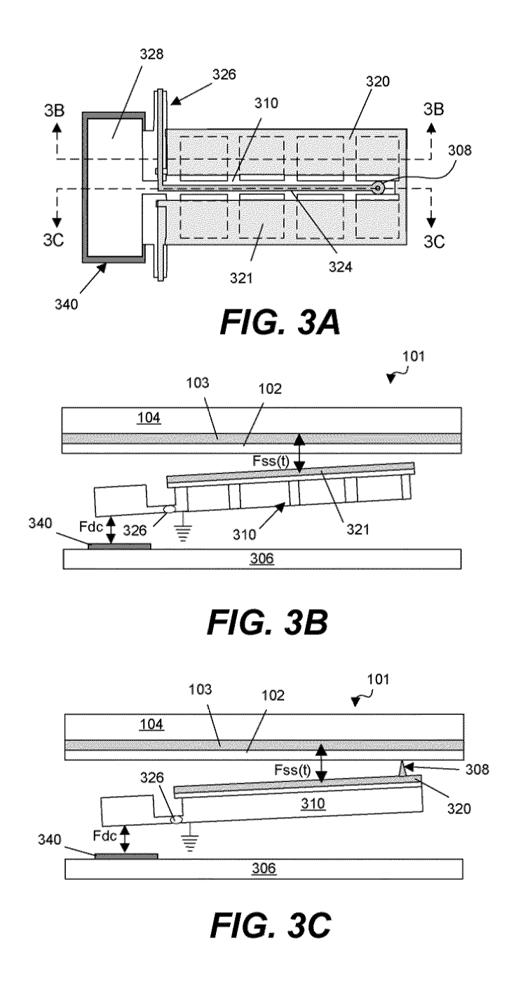

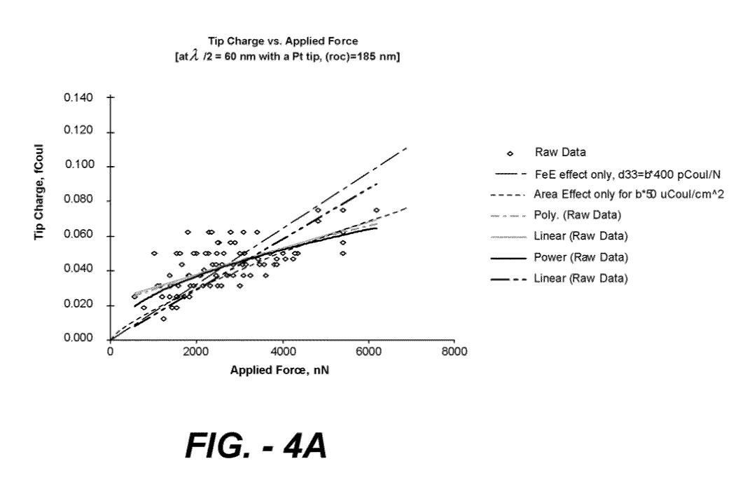

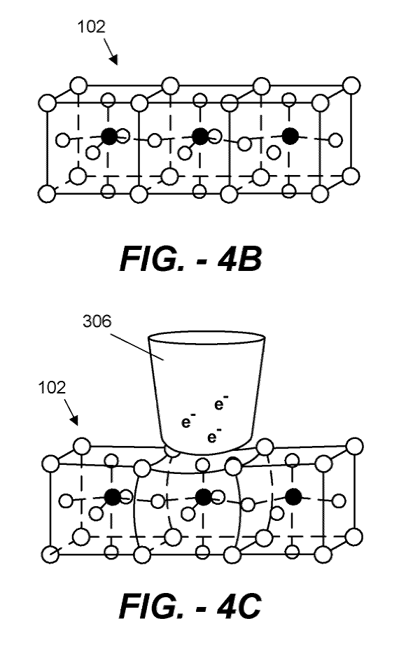

FIG. 3A is a plan view and FIGS. 3B and 3C are cross-sectional side-views of an alternative embodiment of a cantilever 310 for use with embodiments of systems and methods of the present invention. The cantilever 310 is connected and electrically grounded through a tip substrate 306 by way of a torsion beam 326 connected at both ends to beam anchors (not shown). A tip 308 extends from the cantilever 310 toward the media 102 and is preferably connected with circuitry by a trace 324 electrically isolated from the cantilever 310 by an insulating layer. A proximal end 328 of the cantilever 310 (on the left side of the torsion beam 326) is arranged opposite an actuation electrode 340 formed on the tip substrate 306. As above, the torsion beam 326 acts as a fulcrum and the cantilever 310 is pivoted at the torsion beam 326 when a voltage is applied to the actuation electrode 340 causing electrostatic force to attract the conductive structure 328 of the cantilever 310 to the actuation electrode 340. As the cantilever 310 pivots the tip 308 at the distal end of the cantilever 310 is urged toward the media 101 and can be placed in contact or near contact with the media 101. A second conductive structure 320 (referred to herein as a “B-plate”) is supported by the cantilever 310 and electrically isolated from the grounded cantilever 310, for example by an insulating layer. Portions 321 of the B-plate 320 can optionally be suspended between a frame of the cantilever 310 which can decrease rigidity of such portions and reduce parasitic capacitances.

An alternative technique for detecting domain polarization using the B-plate is described in U.S. Ser. No. 12/030,101 entitled “METHOD AND DEVICE FOR DETECTING FERROELECTRIC POLARIZATION,” by Adams et al., incorporated herein by reference. The technique relies, in an embodiment described therein, on applying a probe voltage (or current) across the ferroelectric recording layer and vibrating the cantilever to vary the capacitance of the B-plate. The varying capacitance modulates a carrier signal applied to the B-plate, the modulated carrier signal being electrically isolated (disregarding parasitic capacitances) from the probe voltage. A domain polarization can be determined based on the modulation of the carrier signal.

While embodiments of systems and methods in accordance with the present invention will be described herein with reference to the cantilevers of FIGS. 2A-3C, such embodiments are applicable to cantilevers having different structures and that are actuatable by different techniques. Embodiments described herein should not be construed as being limited to the cantilever structure of FIGS. 2A-3C. For example, alternatively an electrode can be disposed on the tip substrate opposite the distal end of the cantilever, with the cantilever actuated by way of a repulsive electrostatic force applied by the electrode to the grounded cantilever. Alternatively, the cantilever can have a structure biased toward the media and disengaged from the media by way of an attractive electrostatic force applied to the distal end by an actuation electrode. Alternatively, actuation can be achieved by a technique other than application of electrostatic force. For example, in other embodiments the cantilever can be actuated by way of a thermal actuator comprising a thermal bimorph structure disposed along the cantilever. One of ordinary skill in the art, upon reflecting on the teachings provided herein, will appreciate the myriad different cantilever arrangements with which embodiments of systems and methods in accordance with the present invention can be applied.

It has been discovered by the applicant that tips placed in contact or very near contact with the surface of the media may experience stick-slip caused by the surfaces of the tip and media alternatingly sticking to each other and sliding over each other with a corresponding change in the force of friction. It is believed that stick-slip can increase wear on one or both of the tip and the media that can detrimentally affect performance characteristics of the information storage device (e.g., by causing an increase in written bit size with tip wear, and/or reducing an operational lifetime of a tip and/or the media).

Referring again to FIG. 2A-2C, embodiments of systems and methods in accordance with the present invention can comprise applying a time-varying voltage to an actuation electrode 240 when the tip 208 extending from the cantilever 210 passes across the surface of a ferroelectric media 101. For example, the cantilever 210 may be actuated by a DC voltage applied to the actuation electrode 240 so that the tip 208 is in contact or near contact with the surface of a ferroelectric media 101. An additional time-varying voltage applied to the actuation electrode 240 causes a time-varying force tending to cause the cantilever 210 to additionally pivot at the torsion beam 226. The contact force between the surface of the media 101 and the tip 208 can vary with variation in moment force at the torsion beam 226. The time-varying moment force can result in time-varying contact force between the tip 208 and the surface of the media 101. Preferably, the tip 208 remains in contact or very near contact with the media 101 while contact force is varied. Alternatively, there can be some physical and/or electrical separation of the tip 208 and media 101. Time-varying contact force can reduce an amount of stick-slip that occurs between the tip and the surface of the media, reducing associated wear of one or both of the tip and the media. The technique of varying contact force between the tip and the media is referred to hereinafter as “pumping.”

Referring again to FIGS. 3A-3C, alternative embodiments of systems and methods in accordance with the present invention can be applied to amplify time-varying contact force of the tip 308 to the media 101 by vibrating the cantilever 310 between the pivot point (e.g., the torsion beam 326) and the tip 308. Vibration of the cantilever 310 can cause variation of force applied by the tip 308 at the distal end of the cantilever 310 to the surface of the media 101. A B-plate as used in the read technique of U.S. Ser. No. 12/030,101 can be used to vary contact force of the tip 308 to the media 101. The B-plate 320 can act as an electrode similar to the actuation electrode 340, generating an electrostatic force between the B-plate 320 and the bottom electrode 103 of the media 101. Applying a time-varying voltage to the B-plate 320 can create a time-varying electrostatic force attracting the B-plate 320 to the bottom electrode 103 of the media 101. The time-varying electrostatic force causes the B-plate 320 (and by extension the cantilever 310) to vibrate. Variation of contact force occurs at twice the AC frequency of the applied voltage, potentially improving stick-slip performance over application of an additional time-varying voltage to the actuation electrode 240/340. In still other embodiments, amplification of time-varying contact force can be achieved by vibrating the cantilever between the pivot point (e.g., the torsion beam) and the tip using a technique other than application of time-varying voltage to a B-plate. One of ordinary skill in the art will appreciate, in light of these teachings, the different techniques that can be applied to vibrate the cantilever.

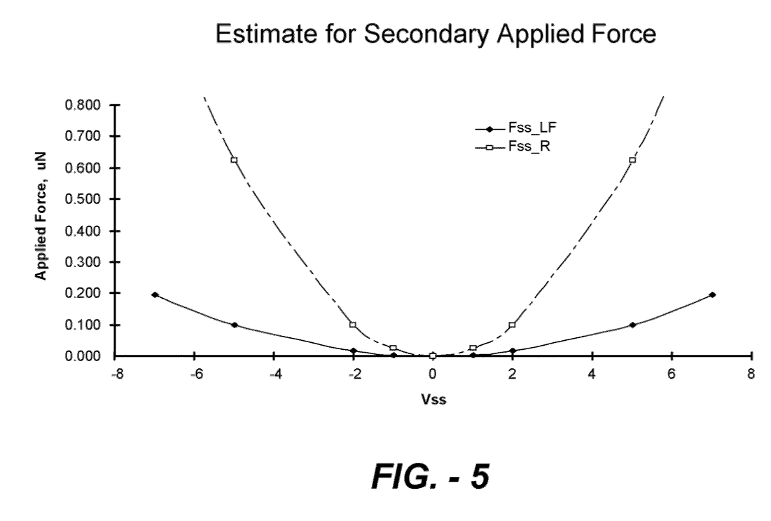

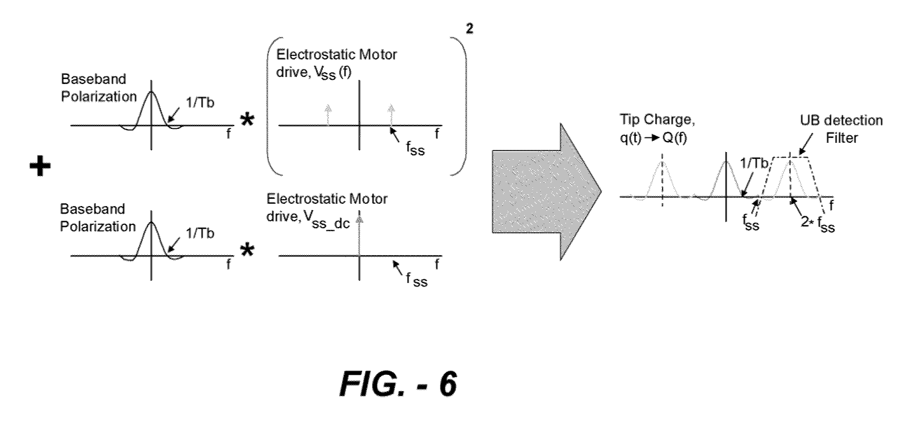

Charge coupled to the tip as the tip passes the surface has been found to vary with an amount of strain induced in the recording layer. FIG. 4A is a plot of tip charge and applied contact force of a tip to the surface of a media having a recording layer comprising PZT. The data was collected using a tip of an atomic force microscope having a tip comprising platinum with a radius of curvature (“roc”) of about 185 nm wherein domains of the sample include a bit length with a half-wavelength of 60 nm. As applied force increases, tip charge increases. Referring to FIGS. 4A and 4B, as the tip passes over ferroelectric domains, the ferroelectric domains are strained, and charge is coupled to the tip. As will now be understood, a charge collected at the tip can vary with a source of strain such as pumping as well as with polarization of the ferroelectric recording layer and relative movement between the tip and the media. It is further believed that strain induced in the recording layer can be amplified by a mechanism that is related to one or both of (1) the cantilever acting as a structural amplifier of contact force of the tip to the surface of the media, and (2) surface waves generated at the media by vibration of the cantilever.

Systems and methods in accordance with the present invention, while reducing wear on one or both of the tip and media can further provide additional techniques for reading data from the ferroelectric recording layer. Embodiments of systems and methods of reading information from a ferroelectric media in accordance with the present invention can comprise varying an amount of contact force applied by a tip to the surface of the ferroelectric media, thereby varying the charge coupled to the tip, and amplifying an amount of strain induced in the recording layer of the media, thereby increasing the charge coupled to the tip. A signal from the coupled charge can be further amplified and filtered to determine polarization over the length of a bit.

Referring to FIG. 5, it is estimated that variation in contact force (Fₛₛ_{_{—}}_{R}) between a tip and media increases where a cantilever is vibrated at a resonance frequency, with increased maximum strain at maximum signal amplitude. The resonance frequency may be the resonance frequency of the cantilever structure, or it may be the resonance frequency of a surface wave at the interface of the tip and media produced by the vibration of the cantilever. For reference, an estimate for the variation in contact force (Fₛₛ_{_{—}}_{LF}) between a tip and media where a cantilever is vibrated at a frequency below the resonance frequency is shown. Increased maximum contact force results in an increase in charge coupled to the tip 308 which increases amplitude of a raw signal passed to a front-end channel by way of a signal trace 324 connected between the tip 308 and the front-end channel.

An embodiment of a method of reading information from a ferroelectric media in accordance with the present invention can comprise applying an electric potential to an actuation electrode and a time-varying voltage to a B-plate of the cantilever or an actuation electrode to vary an amount of contact force applied by a tip to the surface of the ferroelectric media, thereby varying the charge gathered by the tip. FIG. 6 shows composite spectra for tip charge as the tip moves along the media at a frequency of 1/Tb, where Tb is the bit time. The composite spectra has a baseband (“BB”) signal component associated with the electric potential, Vₛₛ_{_{—}}_{dc} (wherein ss refers to “see-saw”), and corresponding to the RF charge signal associated with spontaneous polarization, and an upper band (“UB”) signal component associated with the time-varying voltage, Vₛₛ(t) related to variation in the RF charge signal.

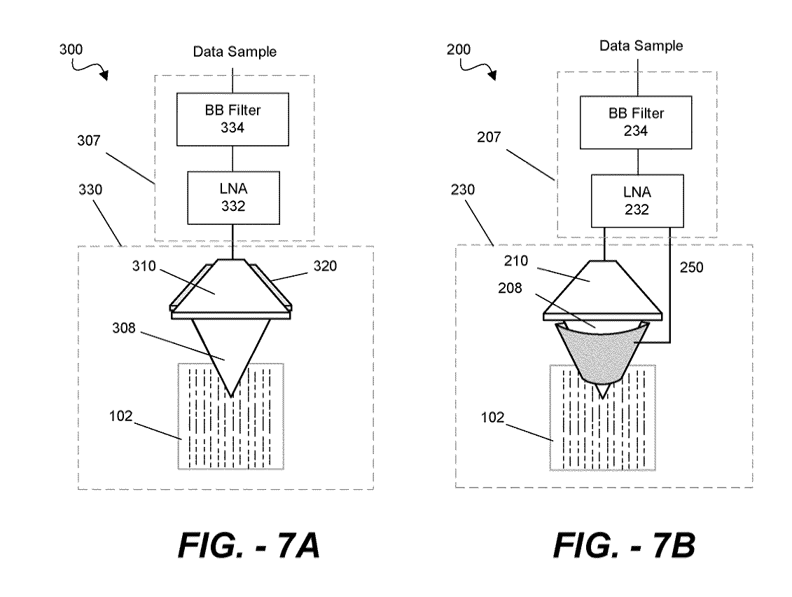

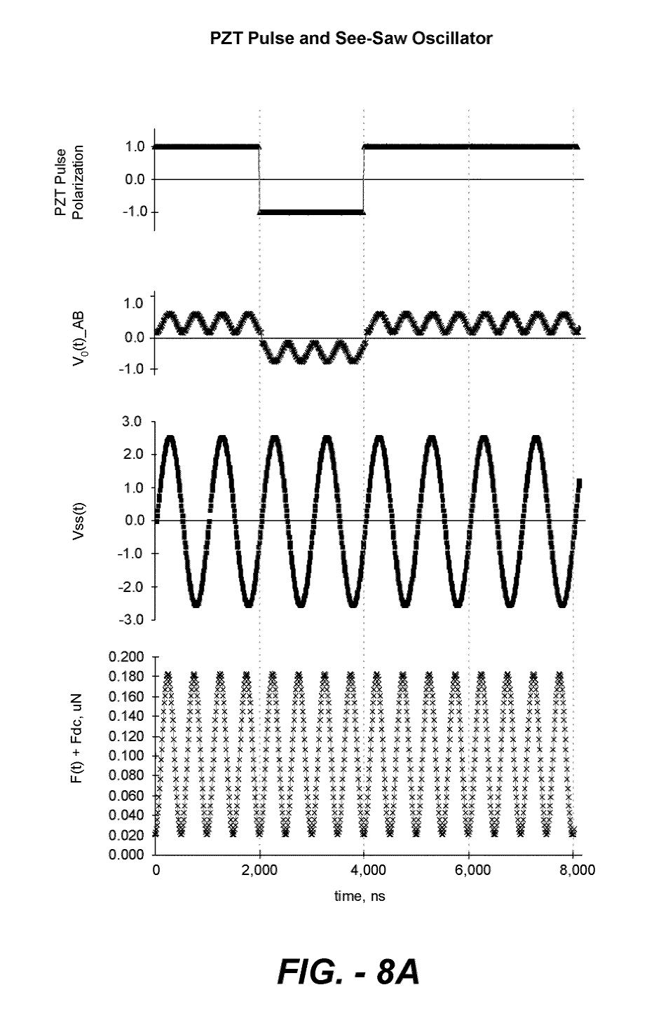

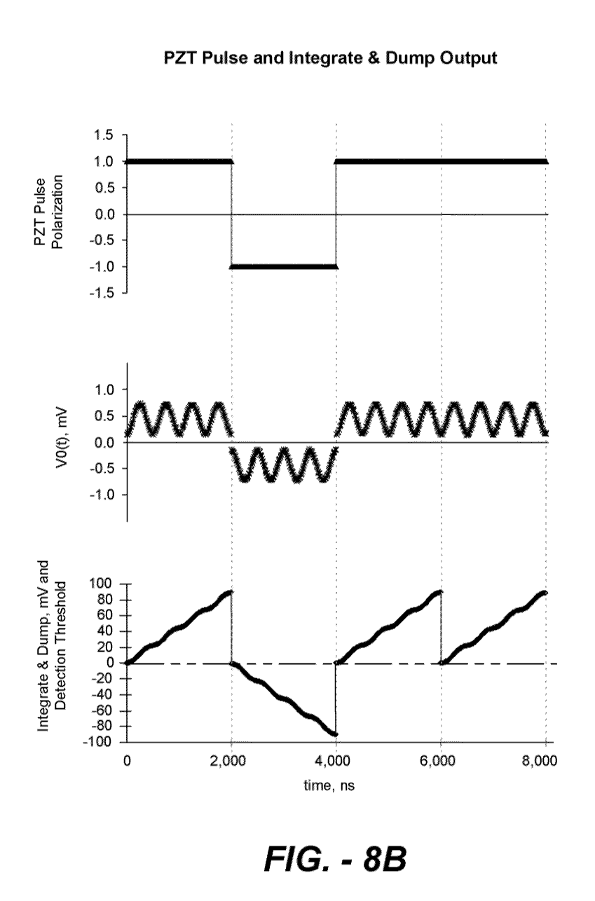

Embodiments of systems and methods in accordance with the present invention can be applied to determine ferroelectric polarization using RF-charge techniques. FIG. 7A is a schematic view of an unguarded front-end channel 307 and FIG. 7B is a schematic view of a guarded front-end channel 207 for a read tip 208,308 applying RF-charge techniques to read information from a ferroelectric recording layer 102 of a media. The front-end channels 207,307 comprise a low-noise charge amplifier (“LNCA”) 232,332 and a baseband filter 234,334 preferably implemented on the tip substrate. A charge coupled from the ferroelectric recording layer 102 of the media to the tip 208,308 generates a signal in the form of displacement current and/or sensed voltage (or voltage potential). The low-noise charge amplifier 232,332 amplifies the signal and polarization information is extracted from the baseband signal in the baseband filter 234,334. The low-noise charge amplifier 232 of the guarded front-end channel 200 is a differential amplifier with one differential input including an active guard 250 for reducing interference from stray electric fields.

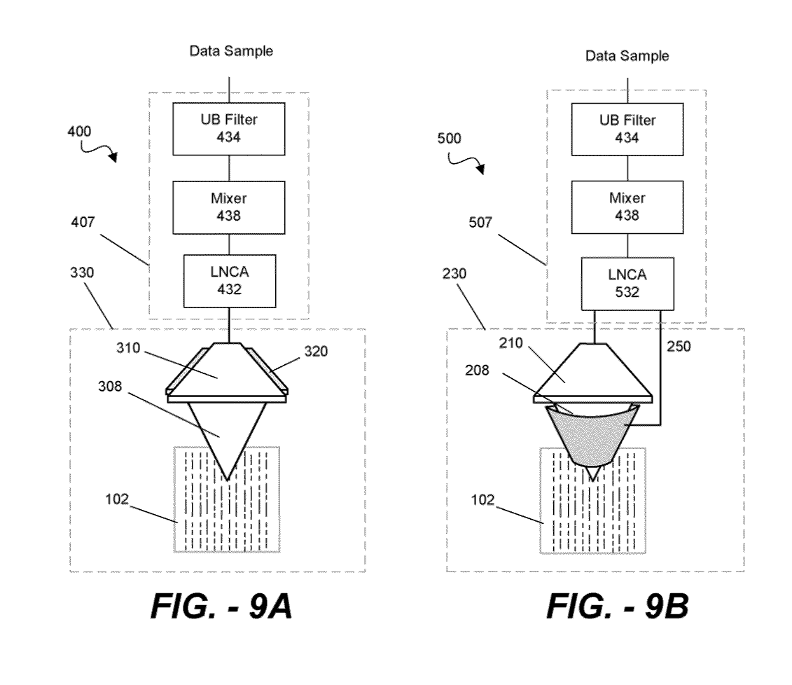

FIG. 8A is a plot of signals from a computer simulation of the front-end channels of FIG. 7A for a read tip passing across a surface of a PZT material. The computer simulation disregards noise from stray electrical fields and parasitic capacitances. The PZT material is modeled in the plot as having a positive polarization across a single bit length (i.e., an “UP” bit) followed by a negative polarization across a single bit length (i.e., a “DOWN” bit), followed by positive polarization across two bit lengths (i.e., two “UP” bits). A DC voltage, V_{dc}, is applied to actuate the cantilever so that the tip is in contact or near-contact with the surface and applying a force, F_{dc}, that comprises a component of the contact force. If the force modulating technique relies on cantilever vibration, a time-varying voltage, Vₛₛ(t), is applied to the B-plate of the cantilever to pump the tip and vary the contact force applied to the PZT material. Alternatively, a time-varying component of the voltage can vary an actuation force tending to pivot the cantilever at the torsion beam. The time-varying voltage, Vₛₛ(t) has a period that is half the length of a bit. The contact force, F(t)+F_{dc}, applied by the tip to the surface of the media increases as the see-saw voltage increases (both positively and negatively). The baseband signal, Vₒ(t), amplified by the low-noise amplifier varies with the contact force applied to the surface of the media, and varies around a charge collected when the see-saw voltage is 0 (and the voltage potential, V_{dc}, dominates). The charge results in a negative voltage when polarization of the bit is “DOWN.” Referring to FIG. 8B, the baseband filter can comprise an integrate-and-dump filter that integrates the baseband signal over the bit time, Tb, and outputs the cumulative charge. The baseband filter improves signal-to-noise ratio (“SNR”) by reducing the affect of spurious noise.

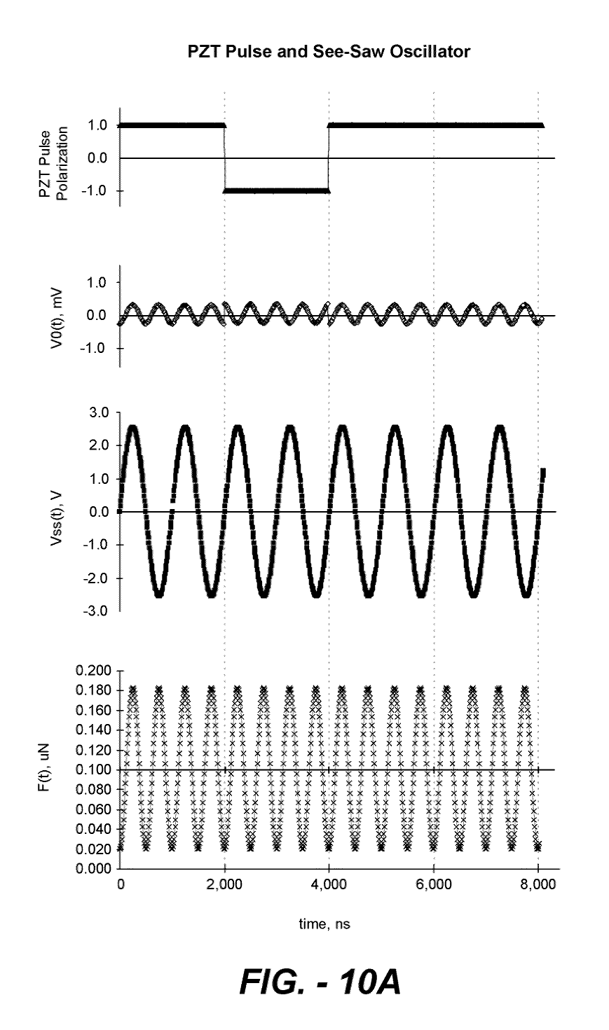

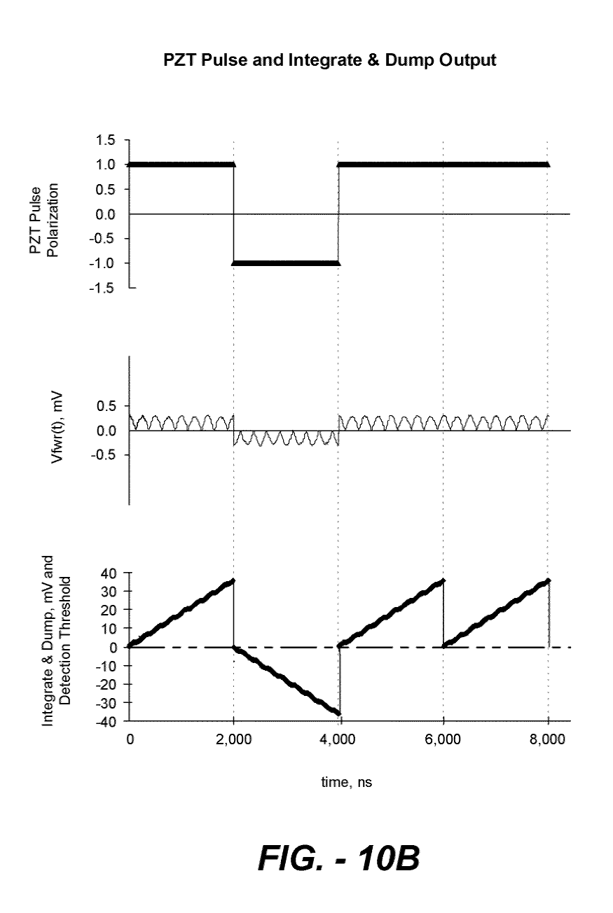

Alternatively, embodiments of systems and methods in accordance with the present invention can be applied to determine ferroelectric polarization based on an upper-band signal associated with pumping when applying RF-charge techniques to determine ferroelectric polarization. FIG. 9A is a schematic view of an unguarded front-end channel 407 and FIG. 9B is a schematic view of a guarded front-end channel 507 for a read tip applying RF-charge techniques to read information from a ferroelectric recording layer of a media. The front-end channels 407,507 comprise a low-noise charge amplifier 432,532, a mixer 438, and an upper-band filter 434. A charge coupled from the ferroelectric recording layer 102 of the media to the tip 208,308 generates a signal in the form of displacement current and/or sensed voltage (or voltage potential), the charge varying with polarization of the ferroelectric recording layer 102 and with contact force. The low-noise amplifier 432,532 amplifies the signal and polarization information is extracted from the upper-band signal in an upper-band filter 434. The low-noise charge amplifier 532 of the guarded front-end channel 507 is a differential amplifier with one differential input including an active guard 250 for reducing interference from stray electric fields.

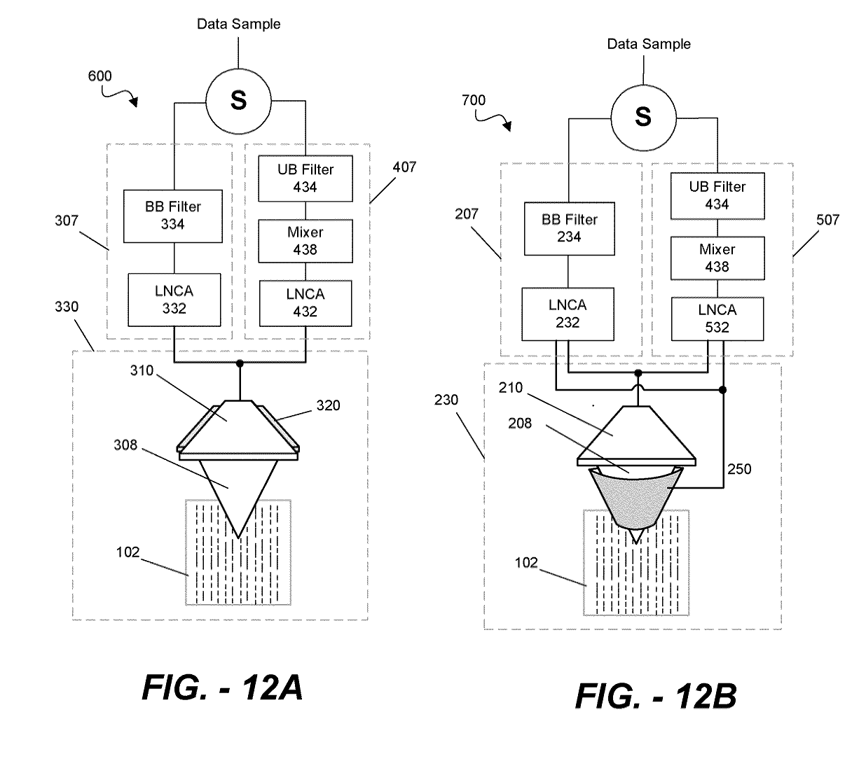

An embodiment of an upper-band filter for use in systems and methods in accordance with the present invention is shown in the schematic circuit diagram of FIG. 11. A see-saw structure cantilever 310 having a read tip 308 extending therefrom is positioned over a ferroelectric recording media (box 330). Actuation is driven by an actuation voltage potential, Vₛₛ_{_{—}}_{dc}. Contact force, F(t) is varied by applying a time-varying voltage, Vₛₛ(t), to the B-plate of the cantilever 310. A charge, q(t) is coupled to the tip 308 and develops a signal in the form of a current, i(t), or sensed voltage. A high-pass filter, C_{ac}, removes the DC component of the signal and the upper-band signal is amplified in a low-noise amplifier 432. An amplified upper-band signal, Vₒ(t), is sent to a mixer (a synchronous full-wave rectifier 438 as shown). The upper-band signal is phase-shifted by the change in polarization of the signal. The mixer 438 converts the input signal for the positively polarized domains to a positive polarity DC voltage and converts the input signal for the phase-shifted, negatively polarized domains to a negative polarity DC voltage. The output of the mixer, V_{fwr}(t), is passed to an integrate-and-dump filter 434 comprising an amplifier and capacitor, C_{I}, that integrates for the length of a bit before dumping the output of the filter, V_{ID}(t), to a detector. The output of the filter 434 is sent to a decision threshold comparator to determine whether the signal collected by the tip corresponds to a “1” or a “0.” A reference oscillator 436 drives the time-varying voltage, Vₛₛ(t), at one-half of a reference frequency (i.e., ½x, where x is a reference frequency). The reference frequency is provided to the mixer 438 to mix the output signal of the low-noise amplifier 432. As shown, the bit length extends across four cycles of pumping, and the delay lock loop (DLL) 440 is driven at one-quarter of the reference frequency to match the bit rate. However, the pumping cycle need not be matched to bit length, where band separation filters are applied. The synchronized DLL 440 closes off the integrate-and-dump filter 434 after each bit (i.e., θ_{dbit}) and dumps the output to the detector.

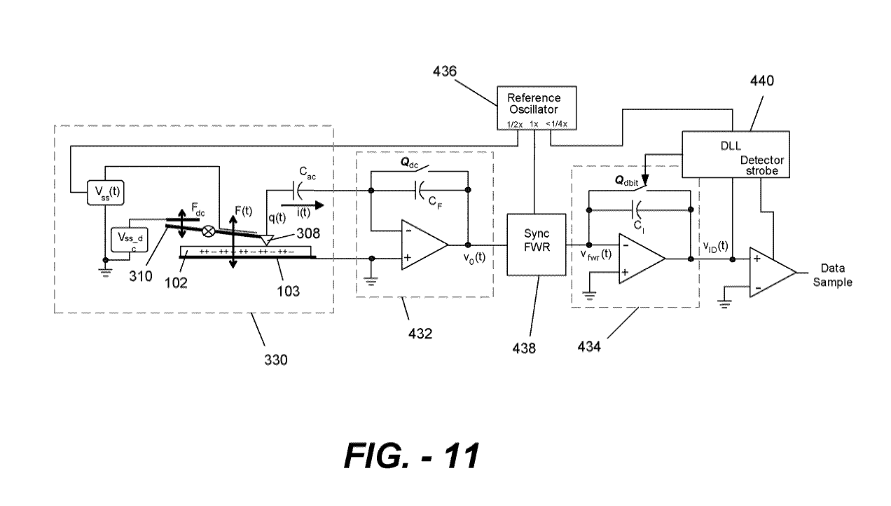

FIG. 10A is a plot of signals from a computer simulation of the front-end channels of FIGS. 9A and 9B for a read tip passing across a surface of a PZT material. The computer simulation disregards noise from stray electrical fields and parasitic capacitance. As in the previous simulation, the PZT material is modeled in the plot as having a positive polarization across a single bit length (i.e., an “UP” bit) followed by a negative polarization across a single bit length (i.e., a “DOWN” bit), followed by positive polarization across two bit lengths (i.e., two “UP” bits). A DC voltage, V_{dc}, is applied to actuate the cantilever so that the tip is in contact or near-contact with the surface and applying a force, F_{dc}, which comprises a component of the contact force. If the force modulating technique relies on cantilever vibration, a time-varying voltage, Vₛₛ(t), is applied to the cantilever to pump the tip and vary the force applied to the PZT. Alternatively, a time-varying component of the voltage can vary an actuation force tending to pivot the cantilever at the torsion beam. The time-varying voltage, Vₛₛ(t) has a period that is half the length of a bit. The contact force, F(t) F_{dc}, applied by the tip to the surface of the media increases as the see-saw voltage increases (both positively and negatively). A signal coupled to the tip is coupled to the upper-band filter by a high-pass filter that allows only the upper-band component of the signal to be passed. The upper-band signal, Vₒ(t)_UB, amplified by the low-noise amplifier varies with the contact force applied to the surface of the media The phase of the upper-band signal shifts by 90° when polarization of the bit is “DOWN.” Referring to FIG. 10B, output of the mixer, V_{fwr}(t), has a positive polarity DC voltage across positively polarized domains and a negative DC voltage across negatively polarized domains. The integrate-and-dump filter integrates the upper-band signal, Int&D, over the bit time, Tb.

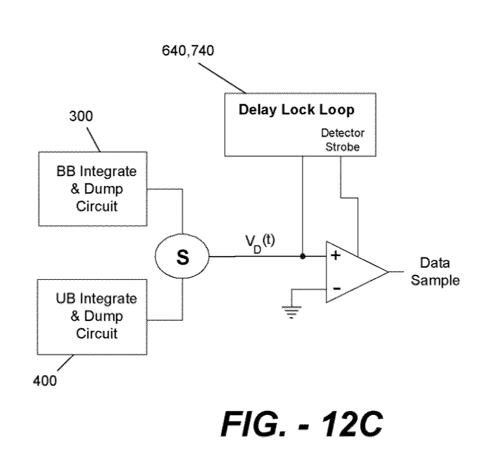

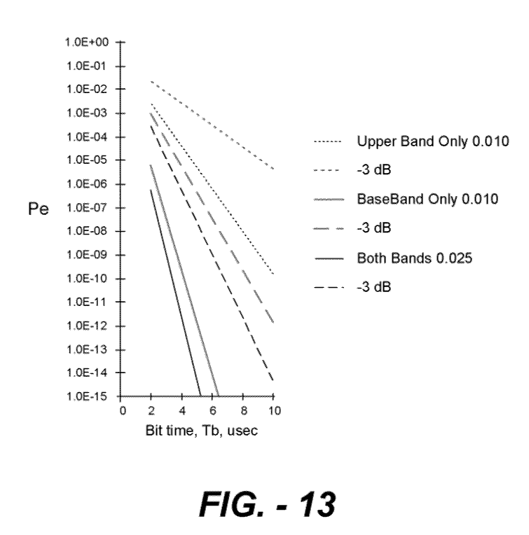

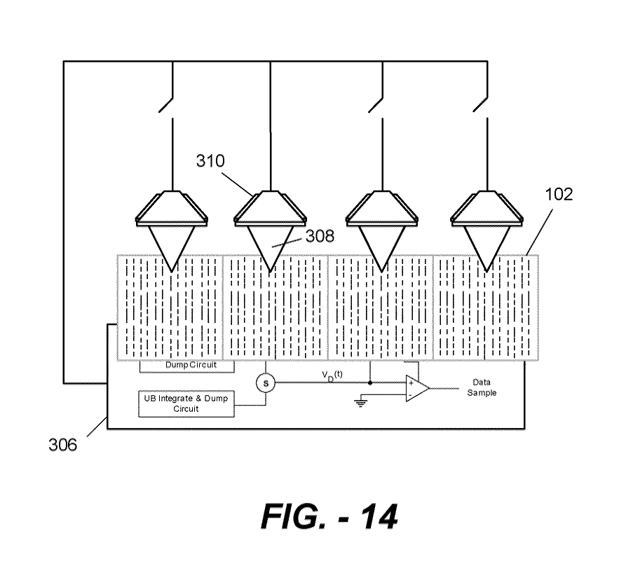

Still further embodiments of systems and methods in accordance with the present invention can comprise both a baseband detector and an upper-band detector. It has been observed that including a baseband detector and an upper-band detector sampling a coupled charge from a read tip applying a pumped RF-charge technique can increase SNR and reduce error probability for a given applied tip force and corresponding wear. Referring to FIGS. 12A and 12B, a signal produced from the coupled charged sampled by the baseband detector 307 benefits from the use of all available energy of the coupled charge and the baseband detector 307 may be preferred until low frequency electronic noise begins to dominate. The upper-band detector 407 can overcome low frequency noise by increasing time-varying force applied to the cantilever 310 and reducing the voltage potential, V_{dc}. Referring to FIG. 12C, the output of the baseband and upper-band detectors 307,407 can be summed and provided to a decision threshold comparator to determine whether the signal collected by the tip corresponds to a “1” or a “0.” The sum can be a weighted sum (favoring one of the baseband detector and the upper-band detector) depending on correlation between noise terms. Referring to FIG. 13, simulation results include calculated error probability, Pₑ, plotted against bit time, Tb for each detection method. The simulation assumes an electronic noise dominated system and Gaussian type process. As can be seen, the baseband detector has improved performance over the upper-band detector. The combined detector is improved further over the baseband detector. The results are shown in dashed lines for an additional loss in SNR of 3 dB, that may result over a lifetime of the product. For example, a loss in SNR may be attributable to tip wear or domain shrinkage that may occur as data fades.

As will be appreciated, combining the information in the DC term (the baseband component) and the AC phase (the upper-band component) can improve the detection SNR, with a corresponding improvement in error rate and/or data rate. Alternatively, the combined detector can enable a reduction in contact force (with an associated reduction in coupled charge) while still achieving satisfactory SNR and error probability when compared with only one of the baseband and upper-band detectors. A summary of results from a simulation of the circuits is provided in Table 1 as follows:

TABLE 1

| Detection | Applied Tip | Input SNR, | Detection | Ideal Prob. | |
|---|---|---|---|---|---|
| Technique | Force, nN | Peak-to-peak: rms | SNR, dist: rms | Error | Result |
| Baseband | 105 | 2.1 dB | 19.1 dB | 1.7e−19 | Highest friction |
| Pumped | 105 to 205 | 6.4 dB | 21.6 dB | 3.7e−33 | Low friction |
| Baseband | <155> | | | | |
| Pumped | 105 to 205 | −7.5 dB | −7.5 dB | 1.5e−4 | Low friction |
| Upper-band | <155> | | | | |
| Pumped | 23 to 186 | 5.7 dB | 18.8 dB | 4.2e−18 | Ultra low friction |
| Baseband | <105> | | | | |
| Pumped | 23 to 186 | −2.3 dB | 17.3 dB | 2.6e−13 | Ultra low friction |
| Upper-band | <105> | | | | |

As will be appreciated, if low frequency (1/f) noise does not become problematic, preferred results may be obtained using the pumped baseband technique. Use of the pumped baseband detection technique simplifies detector circuitry, as will be appreciated from the discussion above. However, as low frequency noise becomes problematic (e.g., in a range of 50-100 KHz as a result of the contemplated electronics), preferred results may be obtained using the pumped upper-band technique, with a modest increase in complexity of the detector circuitry. A reduction in contact force will reduce tip and/or media wear, nominally improving usable lifetime of the tip and/or media.

Efficient use of surface area of the tip substrate for read/write circuitry can benefit performance by minifying the number of tips supported by a channel and/or benefit manufacturing by enabling use of technology for fabricating 0.18 um features. Referring to FIG. 14, it is believed that a channel comprising a detector having circuitry enabling use of both the upper-band and baseband detection techniques can be fabricated with a sufficiently small areal density (i.e., footprint) across the tip substrate 306 to serve as few as four tips 308. In such a scheme, one of the four served tips 308 can be selectively placed in electrical communication with the media 102 by actuating the cantilever 310 from which it extends, as described above, while the other tips remain inactive. An array of such structures and channels can be fabricated to obtain a satisfactory overall data rate.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. An information storage device comprising:
a media including a ferroelectric layer and a conductive layer;
a cantilever actuatable toward the media including:
a tip, and
an electrode associated with the cantilever and electrically isolated from the tip,
wherein when the cantilever is actuated, the tip applies a contact force to strain the media so that a charge is coupled from the ferroelectric layer to the tip;
circuitry to apply a signal to the electrode to generate electrostatic force between the electrode and the conductive layer causing the cantilever to vibrate based on a frequency of the signal; and
wherein vibration of the cantilever causes the strain induced in the media to vary.

2. The information storage device of claim 1 further comprising:
circuitry that can determine a polarization of the ferroelectric media based on a baseband signal generated by the charge coupled to the tip.

3. The information storage device of claim 1 further comprising:
circuitry that can determine a polarization of the ferroelectric media based on an upper-band signal generated by variation in phase of the charge coupled to the tip.

4. The information storage device of claim 1 further comprising:
circuitry that can determine a baseband signal generated by the charge coupled to the tip; and
circuitry that can determine an upper-band signal generated by variation in phase of the charge coupled to the tip; and
circuitry to determine a polarization of the ferroelectric media based on the combination of the baseband signal and the upper-band signal.

5. The information storage device of claim 1, wherein the signal applied to the electrode has a frequency matched to a resonant frequency of one or both of the cantilever and a surface wave generated at the interface of the tip and the media.

6. The information storage device of claim 1, wherein the ferroelectric layer includes one or more of strontium ruthenate, strontium titanate, and lead zirconate titanate.

7. The information storage device of claim 1, wherein the cantilever is pivotably connected with a tip substrate by a torsion beam; and further comprising an actuation electrode formed on the tip substrate to apply an electrostatic force actuating the cantilever.

8. A method of reading information from a media including a ferroelectric layer formed over a conductive layer using a tip extending from a cantilever including an electrode associated with the cantilever comprising:
arranging the tip over the media so that the tip applies a contact force to strain the ferroelectric layer such that a charge is coupled to the tip from the ferroelectric layer;
moving one of the tip and the media at a velocity such that a polarization of the ferroelectric layer positioned at the tip changes so that the charge coupled to the tip appears to the tip as a baseband signal having a radio frequency;
applying a signal to the electrode to generate an electrostatic force between the electrode and the conductive layer causing the cantilever to vibrate based on a frequency of the signal; and
wherein vibration of the cantilever causes the strain induced in the ferroelectric layer to vary.

9. The information storage device of claim 8 further comprising:
detecting the baseband signal; and
determining information based on the baseband signal.

10. The information storage device of claim 8, further comprising:
detecting an upper-band signal generated by variation in phase of the charge coupled to the tip; and
determining information based on the upper-band signal.

11. The information storage device of claim 8 further comprising:
detecting the baseband signal;
determining information based on the baseband signal;
detecting an upper-band signal generated by variation in phase of the charge coupled to the tip; and
determining information based on the combination of the baseband signal and the upper-band signal.

12. The information storage device of claim 8, wherein the signal applied to the electrode has a frequency matched to a resonant frequency of one or both of the electrode and the cantilever.

13. The information storage device of claim 8, wherein the ferroelectric layer includes one or more of strontium ruthenate, strontium titanate, and lead zirconate titanate.

14. The information storage device of claim 8, wherein the cantilever is pivotably connected with a tip substrate by a torsion beam; and further comprising an actuation electrode formed on the tip substrate to apply an electrostatic force actuating the cantilever.

15. An information storage device comprising:
a tip substrate including an actuation electrode;
a cantilever extending from the tip substrate and adapted to be actuated toward the media when a voltage potential is applied to the actuation electrode;
a tip extending from the cantilever, and
a vibration electrode associated with the cantilever;
a media including a ferroelectric layer formed over a conductive layer;
wherein when the cantilever is actuated, the tip applies a contact force to the media so that a charge is coupled from the ferroelectric layer to the tip; and
a front end channel formed in the tip substrate and associable with the tip including circuitry to apply a signal to the vibration electrode to generate electrostatic force between the vibration electrode and the conductive layer causing the cantilever to vibrate based on a frequency of the signal; and
wherein vibration of the cantilever causes the contact force applied by the tip to the media to vary.

16. The information storage device of claim 15, wherein the front end channel further includes:
circuitry that can determine a polarization of the ferroelectric media based on a baseband signal generated by the charge accumulated at the tip.

17. The information storage device of claim 15, wherein the front end channel further includes:
circuitry that can determine a polarization of the ferroelectric media based on an upper-band signal generated by variation in phase of the charge accumulated at the tip.

18. The information storage device of claim 15 wherein the front end channel further includes:
circuitry that can determine a baseband signal generated by the charge accumulated at the tip; and
circuitry that can determine an upper-band signal generated by variation in phase of the charge accumulated at the tip; and
circuitry to determine a polarization of the ferroelectric media based on the combination of the baseband signal and the upper-band signal.

19. The information storage device of claim 1, wherein the signal applied to the vibration electrode is an alternating current having a frequency matched to a resonant frequency of one or both of the vibration electrode and the cantilever.

20. The information storage device of claim 1, wherein the ferroelectric layer includes one or more of strontium ruthenate, strontium titanate, and lead zirconate titanate.
